(19) United States
(12) Patent Application Publication
(10) Pub. No.: US 2023/0356797 A1
(43) Pub. Date: Nov. 9, 2023

(54) Method and Apparatus for Detecting a Specific Movement of a Bike

(71) Applicant: Robert Bosch GmbH, Stuttgart (DE)

(72) Inventors: Gustav Traeff, Lund (SE); Jakob Andren, Lund (SE); Linnea Andersson, Lund (SE)

(21) Appl. No.: 18/310,979

(22) Filed: May 2, 2023

(30) Foreign Application Priority Data
May 4, 2022 (DE) 102022204408.8

(51) Int. Cl. B62J 45/414; B62J 45/416; B62J 45/42

(52) U.S. Cl. CPC B62J 45/414; B62J 45/416; B62J 45/42

(57) ABSTRACT

A method for detecting a movement of interest of a bike is disclosed. The method includes (i) sensing first sensor data by way of a first sensor, (ii) determining an indicator based on the first sensor data, wherein the indicator indicates a probability of a presence of a movement of interest of the bike , (iii) sensing second sensor data by way of a second sensor, wherein the second sensor data describes a strength of a movement of the bike, (iv) determining a weighting factor based on the second sensor data, (v) weighting the indicator by the weighting factor, and (vi) detecting whether the movement of interest is given based on the weighted indicator.

This application claims priority under 35 U.S.C. § 119 to application no. DE 102022204408.8, filed on May 4, 2022 in Germany, the disclosure of which is incorporated herein by reference in its entirety.

### BACKGROUND

Electric bikes are enjoying great popularity. In this context, particularly high-priced models are also available, especially in the area of electric bikes. This makes electric bikes an attractive target for thieves.

In order to provide an additional sense of safety to an owner of an electric bike, it can be equipped with sensors that monitor a movement of the bike and its position. If the bike is moved, the owner will be informed and in some cases can even track a movement of the bike.

In order to avoid unnecessary notifications to an owner of a bike, a robust detection of relevant movements of the bike is necessary. For example, it is intended to avoid triggering a notification when the bike is accidentally moved or when there is merely interference acting on the sensors of the bike, leading to the detection of a movement of the bike and causing a notification to the owner.

### SUMMARY

The method according to the disclosure for detecting a movement of interest of a bike comprises sensing first sensor data by means of a first sensor, determining an indicator based on the first sensor data, wherein the indicator indicates a probability of a presence of a movement of interest of the bike, sensing second sensor data by means of a second sensor, wherein the second sensor data describes a strength of a movement of the bike, determining a weighting factor based on the second sensor data, weighting the indicator by the weighting factor, and detecting whether the movement of interest is given based on the weighted indicator.

The apparatus according to the disclosure for detecting a movement of interest of a bike comprises a first sensor configured to sense first sensor data, a second sensor configured to sense second sensor data, wherein the second sensor data describes a strength of a movement of the bike, and a calculation unit configured to determine an indicator based on the first sensor data, wherein the indicator indicates a probability of a presence of a movement of interest of the bike, to determine a weighting factor based on the second sensor data, to weight the indicator by the weighting factor, and to detect whether the movement of interest is given based on the weighted indicator.

Preferably, the first sensor and the second sensor are different types of sensors. The first sensor is any kind of sensor, wherein the sensor data provided by the first sensor is suitable for inferring a movement of interest of the bike. A movement of interest is either a specific type of movement, for example a carrying or pushing of the bike, or a movement that is not caused by a random bumping of the bike. Because a movement of the bike changes a variety of measurable characteristics, the first sensor can be selected differently. For example, the first sensor is in particular an accelerometer, a magnetic field sensor, a gyroscopic sensor, an optical sensor, or an acoustic sensor.

Based on the first sensor data, an indicator is determined, which indicates a probability of a presence of a movement of interest of the bike. Thus, in particular, it is possible to compare the first indicator to a threshold and to detect the presence of the movement of interest of the bike when the indicator exceeds the threshold. However, because the indicator does not necessarily directly correspond to the first sensor data, but rather is calculated from it, the indicator can increase comparatively slowly over time. This can result in a delay in detecting the movement of interest. Accordingly, the indicator can decrease comparatively slowly when the movement of interest is no longer given, and thus it is not immediately recognized that the movement of interest has ended. Thus, it is advantageous when the indicator is weighted by a weighting factor determined on the basis of the second sensor data.

The second sensor data reflects a strength of a movement of the bike, regardless of which movement of the bike is in question. Thus, the second sensor data not only indicates whether there is a movement of interest of the bike, but also whether there is any movement of the bike. The second sensor is in this case preferably more sensitive to a movement of the bike or is a particularly responsive sensor. For example, the second sensor is an accelerometer, and the second sensor data describes an acceleration occurring upon a vibration of the bike.

A weighting factor is determined based on the second sensor data. The indicator is weighted with the weighting factor. In other words, the second sensor data sets filter parameters that relate to a filtering of the temporal curve of the indicator. Thus, the indicator is weighted more strongly, in particular, when there is a comparatively strong movement of the bike and is weighted comparatively less strongly when no movement of the bike is detected by the second sensor. This results, for example, in the indicator being weighted particularly weakly when a movement of interest has ended and thus no movement of the bike is detected by the second sensor. In this case, the indicator drops off particularly quickly, and it is also quickly recognized that the movement of interest of the bike is no longer given. Accordingly, the detection of whether the movement of interest is based on the weighted indicator, i.e., on the basis of the indicator weighted by the weighting factor.

Preferred embodiments of the disclosure are further described below.

Preferably, the second sensor is an accelerometer configured in particular to sense an existing acceleration along multiple axes. Accelerometers are particularly responsive and respond to any movement of the bike. Thus, a reliable indicator can be provided in order to determine a strength of a movement of the bike. Preferably, the existing acceleration is sensed along multiple axes, which is therefore advantageous, because the accelerometer is not to be aligned in a particular way in relation to the bike.

Further, it is advantageous for the first sensor to be a gyroscopic sensor, an accelerometer, a magnetic field sensor, an optical sensor, or an acoustic sensor. With any of the aforementioned types of sensors, it is possible to infer certain movements of interest of the bike. For example, it is possible to determine by means of a gyroscopic sensor whether the bike is carried, or to determine by means of a magnetic sensor whether the bike is pushed backward, or to determine by means of an optical sensor whether a movement of the bike takes place in a particular direction, or to determine by means an acoustic sensor whether the bike is pushed.

Further, it is advantageous when the weighting factor is a factor that increases with increasing strength of the movement and decreases with decreasing strength of the movement. Thus, movements of interest of the bike are determined more quickly, and an end of the presence of a movement of interest is also detected more quickly.

Preferably, the weighting factor is determined from the second sensor data such that it falls within a range of values between 0 and 1. Thus, for example, thresholds for the indicator can be maintained, because the weighted indicator will also lie within a range of values as well as the non-weighted indicator.

Further, it is advantageous when, while determining the weighting factor, an envelope of a temporal curve of the second sensor data is calculated, a value of the envelope is read as the characteristic value for a considered time point, and the weighting factor is calculated from a weighting function depending on the characteristic value, wherein the weighting function is a distribution function that assigns a weighting factor to each characteristic value. For example, a temporal curve of the second sensor data can indicate an acceleration that will occur in different directions upon contact of the bike or a movement of the bike. For example, the second sensor data in particular describes vibrations that occur when the bike is bumped. It is therefore advantageous to calculate an envelope from the temporal curve of the second sensor data so that an indicator is provided that continuously indicates a strength of the movement. A value of the envelope is read as the characteristic value for a considered time point. In other words, this means that the values of the envelope are used for a further processing of the second sensor data. The weighting factor is calculated based on a weighting function depending on the characteristic value. The characteristic value is in this case converted into the weighting factor based on a calculation rule. The weighting function is a predefined function. The weighting function is further a distribution function, in particular what is referred to as a “log-logistic distribution.” The weighting function in this case preferably takes on at least a value of 0 and at most a value of 1, or is at least contrary to these limit values. The weighting function thus projects the characteristic value to a range of values between 0 and 1. This is not necessarily a linear process. Rather, the choice of weighting function allows for strong movements, for example, to have a greater impact on the weighting of the indicator than comparatively weak movements.

Preferably, the weighting function is defined as follows:

f(x, α)=1−(1/(1+(x/β)²)

The characteristic value is in this case referred to as “x,” and the configurable parameter is referred to as “α.” The configurable parameter is a selectable parameter that describes an increase in the weighting of the indicator between weak and strong movements. The configurable parameter is to be determined or optimized in, e.g., an experimental manner. In principle, however, the configurable parameter can be selected as desired. The function f(x, α) describes the weighting factor.

Preferably, the envelope is determined by a high-pass filtering and/or a low-pass filtering of the second sensor data. Thus, the envelope can be generated by applying filters from the second sensor data. Thus, an analog signal processing is optionally also possible.

Further preferably, the temporal curve of the second sensor data is further subjected to a bias correction when determining the envelope. In particular, this means that the values of the envelope are raised or lowered as a whole. Thus, continuous movement portions can in particular be filtered, and unwanted influences on the weighting factor can be avoided. Thus, the influence of gravity on measured accelerations is in particular compensated for by the bias correction.

The apparatus according to the disclosure is in particular configured to carry out the method according to the disclosure and includes all of the advantages of the method according to the disclosure.

### BRIEF DESCRIPTION OF THE DRAWINGS

Exemplary embodiments of the disclosure are described in detail hereinafter with reference to the accompanying drawings. The drawings include:

FIG. 1 a schematic illustration of a bike with an apparatus according to the disclosure,

FIG. 2 a signal flow diagram illustrating a weighting of an indicator based on second sensor data,

FIG. 3 a first diagram illustrating a temporal curve of the second sensor data, and

FIG. 4 a second and a third diagram showing a curve of an indicator and a weighted indicator.

### DETAILED DESCRIPTION

FIG. 1 shows an electric bike 1 comprising an apparatus for detecting a movement of interest of the bike 1. The movement of interest is in this case a movement of the bike 1 that leads to a notification of a user when the movement of interest is detected. In this context, the movement of interest is in particular a movement during which the bike is moved away from its parking space.

The apparatus comprises a first sensor 2, a second sensor 3, and a calculation unit 4. The sensor data sensed by the first sensor 2 and the second sensor 3 is transmitted to the calculation unit 4 for further evaluation.

First sensor data is sensed by the first sensor 2 and, based on the first sensor data, an indicator is determined, which indicates a probability of a presence of a movement of interest of the bike 1. For example, the first sensor 2 is a gyroscopic sensor. With the gyroscopic sensor, movements of the bike about a respective axis of rotation in three axes are determined. A covariance matrix is calculated based on this information. The determinant of such a covariance matrix is an indicator showing a probability of the bike 1 being carried. The indicator has the property that it increases when a non-correlated movement of the bike is determined from the first sensor data. Also, the indicator decreases when a correlated movement is determined from the first sensor data. The correlation of the movement describes a probability of the bike being carried, wherein the probability is lower with high correlation than with comparatively low correlation.

Alternatively, the first sensor 2 is a magnetic field sensor, for example. This is arranged in the region of a power unit of the bike 1 and is stimulated by a movement of a motor of the power unit when the bike 1 is pushed backward. This is justified in that the motor or associated mechanism is moved over the chain of the bike 1 when the bike 1 is pushed backwards. In this case, an indicator is determined from the first sensor data, which, as the value increases, describes an increasing probability of presence of a rearward pushing of the bike 1, and which drops accordingly when the probability of presence of a rearward pushing of the bike 1 decreases.

The determination of the indicator can be based on different sensor data of different sensors 2. However, common to this determination of the indicator is that a probability of a presence of a movement of interest (e.g., a rearward pushing of the bike or a carrying of the bike) is indicated. Typically, the indicator in this case increases over time given a longer duration of the movement of interest of the bike. Accordingly, the indicator drops over time when the movement of interest no longer exists. The indicator therefore does not directly indicate whether a movement of interest is present because the probability of detecting a presence of a movement of interest increases when the movement of interest takes place for a longer period. The same applies to a decrease in the indicator.

For the final detection of a movement of interest, the indicator is weighted by a weighting factor. The weighting factor is in this case dependent on a strength of a movement of the bike 1. This is detected by the second sensor 2 and provided as the second sensor data of the calculation unit 4. Based on the second sensor data, the weighting factor is selected and multiplied by the indicator. The weighting factor is in this case determined such that it falls within a range of values between 0 and 1. The weighting factor increases with increasing strength of the movement sensed by the second sensor and decreases accordingly with decreasing strength of the movement sensed by the second sensor 2.

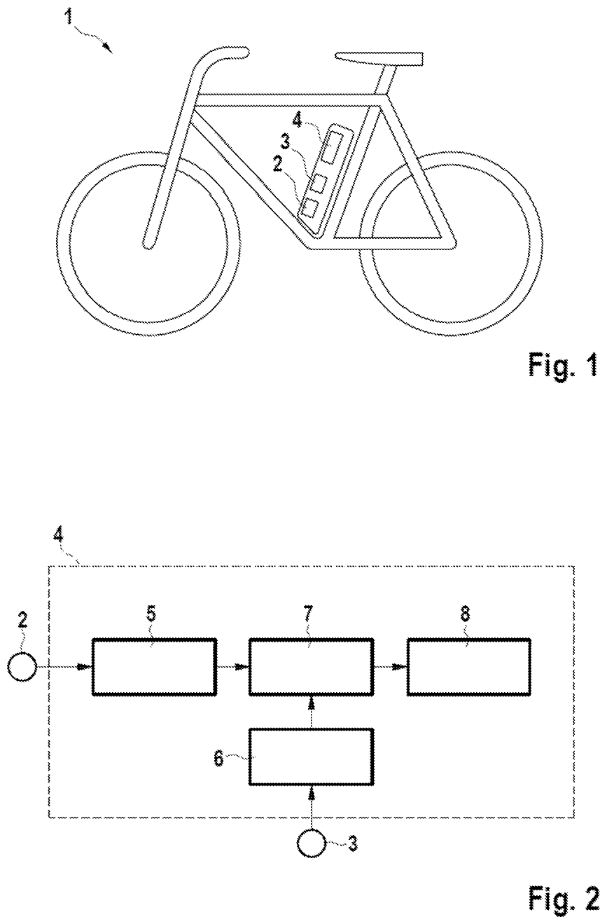

An exemplary signal flow in the calculation unit 4 is shown in FIG. 2. The calculation unit 4 comprises a first sensor data processing unit 5, which is configured to receive the first sensor data from the first sensor 2. The first sensor data processing unit 5 determines the indicator based on the first sensor data.

The calculation unit 4 further comprises a second sensor data processing unit 6, which is configured to receive the second sensor data from the second sensor 3. The second sensor data processing unit 6 determines the weighting factor based on the second sensor data. The indicator and weighting factor are provided to and multiplied by a weighting unit 7. The result is a weighted indicator, which is output to a decision unit 8. From the decision unit 8, the weighted indicator is compared to a predefined threshold. If this threshold is exceeded, then it is detected that the movement of interest is given. If the weighted indicator is below the threshold, then it is detected that the movement of interest is not given. The decision unit 8 optionally sends a notification to a user when the movement of interest is given.

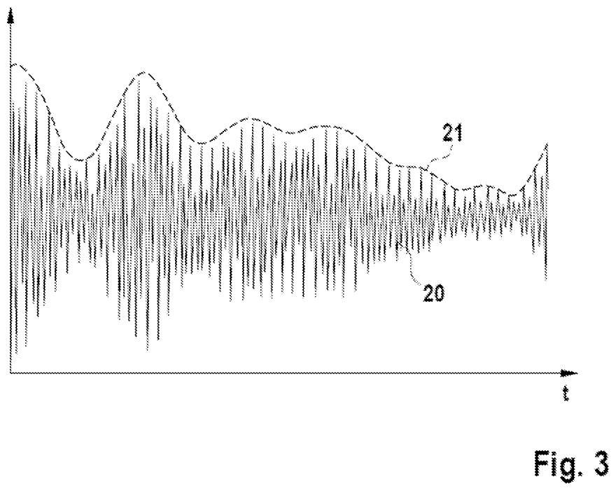

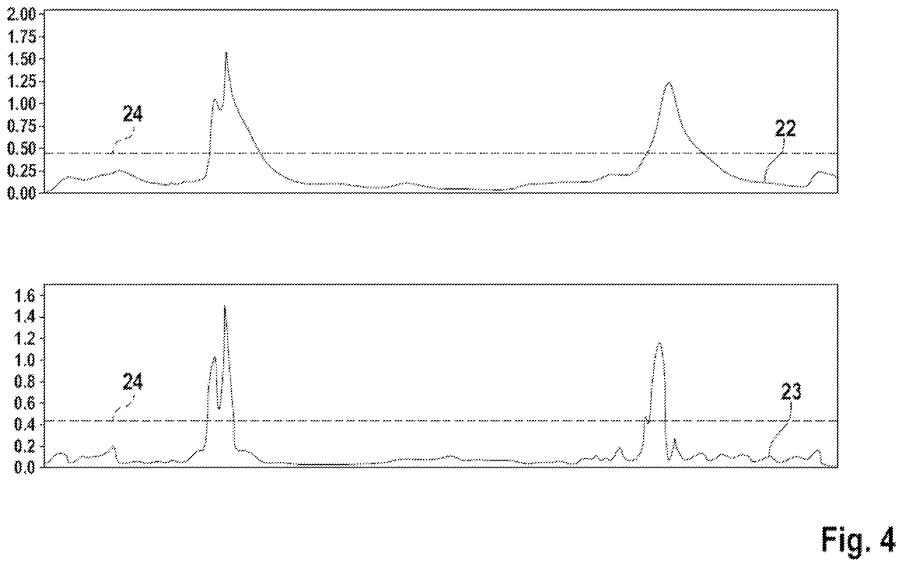

In the following, an advantageous method is described for determining the weighting factor from the second sensor data. For this purpose, an exemplary temporal curve 20 of the second sensor data is shown in FIG. 3. The second sensor 3 is in this case an accelerometer, which is arranged on the bike 1. If the bike 1 is moved, high-frequency vibrations are detected by the second sensor 3, which result from a movement of the bike 1. In particular, the amplitudes or the amplitude curve of the second sensor data can in this case be considered as a measured value for a strength of the movement of the bike 1. This amplitude curve is described by an envelope 21 of the temporal curve 20 of the second sensor data and is used for determining the weighting factor. In order to determine the strength of the movement of the bike 1 for a specific time point, the output signal of the second sensor 3, i.e. the second sensor data, is not further considered directly, but rather the envelope curve 21 is considered. For this purpose, a value of the envelope 21 is read as the characteristic value for a considered time point and is used for the further processing.

The characteristic value is selected such that it takes on exclusively positive values and has a response time of preferably 0.5 seconds, which corresponds to a value of (1/cutoff frequency). The characteristic value is therefore very sensitive to light vibrations, whereas it is robust against larger errors caused by, for example, a rotational movement of the second sensor 3 counter to a gravitational direction. The cutoff frequency preferably has the value 2 Hz, but can take on other values as well.

The weighting factor is calculated by means of a weighting function depending on the characteristic value read. This means that a function is stored that defines the weighting factor depending on a characteristic value. This weighting function is a distribution function, in particular a log-logistic distribution.

In order to determine the characteristic value from the temporal curve of the second sensor data, the envelope 21 is preferably determined from the temporal curve 20 of the second sensor data by means of a high-pass filtering, a low-pass filtering, and a bias correction. The following in particular applies:

x=LF*|HF*|\vec{a}|−bias|

Where x is the characteristic value. LF is the transfer function of a low-pass filter, HF is the transfer function of a high-pass filter, and a is an acceleration vector sensed by the second sensor 3.

The second sensor data is sampled at 50 Hz in the example described and is initially provided as three-dimensional sensor data, i.e., sensor data in which an acceleration in its strength and direction is defined in three-dimensional space. Thus, in this case, the second sensor data are acceleration vectors. Because only the strength of the movement of the bike 1 is required, the strength is determined from an amount of such an acceleration vector.

The weighting function is defined as follows:

f(x, α)=1−(1/(1+(x/α)²)

It can be seen that the weighting function is a function depending on the characteristic value and a configurable parameter α. The parameter αis in this case a value that defines a slope of the weighting function.

The low-pass filtering removes the high-frequency portion shown in FIG. 3 from the temporal curve 20 of the second sensor data. The high-pass filtering removes signal portions resulting, e.g., from a drifting of the second sensor data. The bias correction adjusts the temporal curve 20 of the second sensor data with respect to a predefined zero value. This means that, in particular, an offset is removed from the temporal curve 20 of the second sensor data, which is caused, e.g., by the existing gravity. The bias correction is in particular performed in order to eliminate the influence of gravity from the acceleration information of the second sensor data.

By applying the weighting function, the characteristic value is projected, i.e. mapped, to the range of values from 0 to 1. The weighting factor determined in this way is multiplied by the indicator determined based on the first sensor data.

For example, the indicator is a characteristic value Cov(y), which is dependent on the first sensor data, which is referred to herein as y. The designation Cov(y) is selected herein illustratively for an exemplary characteristic value resulting from a covariance matrix as previously described. If weighted according to the disclosure, this leads to a weighted indicator, which can be referred to as Cov_{gated} (x, y, α), because it is dependent on the first sensor data y, the characteristic value x, and the adjustable parameter α. The “gated” index is selected such that a weighting of sensor data can also be referred to as gating.

The following thus applies:

Cov_{gated}(x, y, α)=Cov(y)*f(y, α)

At the top of FIG. 4, a temporal curve of the indicator is shown in a first curve 22. In addition, a temporal curve of the weighted indicator in a second curve 23 is shown below as the comparison value. It can be seen that the weighted indicator rises faster over time, and in particular decreases faster. The presence of the movement of interest is detected when a threshold 24 is exceeded. It follows that the existing movement of interest is detected in the weighted indicator for a comparatively short period of time. However, in reality this maps the actually existing movement of interest in a much more accurate manner.

A method is thus created by which the information of the two sensors is combined. In so doing, there follows a weighting of an indicator based in this case on second sensor data, which describe a strength of the movement of the bike 1. The strength of the movement of the bike 1 is in this case preferably determined from a vibration of the bike 1. However, it is noted that the strength of the movement of the bike can alternatively also be determined by different sensors, i.e., not necessarily by accelerometers. The sensor need only be suitable for detecting the strength of a movement of the bike 1. A gyroscopic sensor can thus also be used in order to detect the movement of the bike 1 or the strength of the movement of the bike 1. However, it is advantageous when the first sensor 2 and the second sensor 3 are different sensor types. The weighting of the indicator is also referred to as “gating.”

The characteristic value is particularly suitable for the weighting of other values or indicators of existing movements of the bike 1. Over a temporal curve, the weighting of the indicator by the weighting factor can also be considered a filtering of the temporal curve of the indicator. Given the weighting factor, it is in this case possible that the information of two different types of sensors be combined in a robust manner, and the detection of a movement of interest be designed to be error-free. This can be done in a particularly efficient manner, because few calculations are necessary for determining the weighted indicator. Furthermore, it is possible that different indicators can be weighted by means of the same weighting factor. By means of this procedure, it is possible that two different indicators are weighted based on the sensor data of a single second sensor 3, the different weighted indicators being optionally aggregated during the further course. The method is in this case further independent of a calibration of the individual sensors and can thus be implemented in reality in a particularly cost-effective manner.

In addition to the above disclosure, reference is explicitly made to the disclosure of FIGS. 1 to 4.

What is claimed is:

1. A method for detecting a movement of interest of a bike, comprising:
sensing first sensor data by way of a first sensor;
determining an indicator based on the first sensor data, wherein the indicator indicates a probability of a presence of a movement of interest of the bike;
sensing second sensor data by way of a second sensor, wherein the second sensor data describes a strength of a movement of the bike;
determining a weighting factor based on the second sensor data;
weighting the indicator by the weighting factor; and
detecting whether the movement of interest is given based on the weighted indicator.

2. The method according to claim 1, wherein the second sensor is an accelerometer.

3. The method according to claim 1, wherein the first sensor is a gyroscopic sensor.

4. The method according to claim 1, wherein the weighting factor is a factor that increases with increasing strength of the movement and decreases with decreasing strength of the movement.

5. The method according to claim 1, wherein the weighting factor is determined from the second sensor data such that it falls within a range of values between 0 and 1.

6. The method according to claim 1, wherein when determining the weighting factor:
an envelope of a temporal curve of the second sensor data is calculated, a value of the envelope is read as the characteristic value for a considered time point, and the weighting factor is calculated from a weighting function depending on the characteristic value, wherein the weighting function is a distribution function that allocates a weighting factor to each characteristic value.

7. The method according to claim 6, wherein the weighting function is defined as follows:
f(x, α)=1−(1/(1+(x/β)²),
wherein x is the characteristic value and a is a configurable parameter.

8. The method according to claim 6, wherein the envelope is determined by way of a high-pass filtering and/or low-pass filtering of the second sensor data.

9. The method according to claim 8, wherein the temporal curve of the second sensor data is further subjected to a bias correction when determining the envelope.

10. An apparatus for detecting a movement of interest of a bike, comprising:
a first sensor configured to sense first sensor data;
a second sensor configured to sense second sensor data, wherein the second sensor data describes a strength of a movement of the bike; and
a calculation unit configured to:
determine an indicator based on the first sensor data, wherein the indicator indicates a probability of a presence of a movement of interest of the bike,
determine a weighting factor based on the second sensor data,
weight the indicator by the weighting factor, and
detect whether the movement of interest is given based on the weighted indicator.

11. The method according to claim 2, wherein the accelerometer is configured to sense an existing acceleration along multiple axes.

12. The method according to claim 3, wherein the gyroscopic sensor is configured to sense an existing rotation along multiple axes of rotation.

13. The method according to claim 7, wherein the envelope is determined by way of a high-pass filtering and/or low-pass filtering of the second sensor data.

14. The method according to claim 13, wherein the temporal curve of the second sensor data is further subjected to a bias correction when determining the envelope.
